(19) United States
(12) Patent Application Publication
(10) Pub. No.: US 2005/0100107 A1
(43) Pub. Date: May 12, 2005

(54) Composite carrier peak limiting method

(76) Inventors: Thomas Williston Head, Great Meadows, NJ (US); Kaushal Dhar, Hackettstown, NJ (US); Munawar Hussein Kermalli, Floral Park, NY (US); Michael Newell, Hackettstown, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/706,405

(22) Filed: Nov. 12, 2003

(51) Int. Cl. H04K 1/10

(52) U.S. Cl. 375/260

(57) ABSTRACT

A method for reducing the PAR of a composite carrier includes obtaining the in-phase and quadrature components for each of the carriers in the composite carrier, computing vector magnitudes corresponding to each carrier, then adding the vector magnitudes and comparing the resulting sum to a threshold. If the sum exceeds the threshold, at least of the one of the carriers are attenuated, thereby reducing the PAR of the composite carrier. In one embodiment, only the carrier or carriers having significantly larger vectors are attenuated. The pre-calculation and the subsequent attenuation process allows the composite carrier PAR to be reduced to avoid peak regrowth when the carriers are ultimately combined and transmitted.

### BACKGROUND OF THE INVENTION

1. Field of the Invention

The present invention relates to wireless communication systems.

2. Description of the Related Art

Wireless communication systems include base stations containing one or more amplifiers that amplify multi-channel baseband CDMA signals around one or more carriers. As is known in the art, the signals transmitted by the base station may use spread spectrum techniques based on CDMA and wideband CDMA and have a non-constant envelope at the RF frequency with a high peak-to-average power ratio (PAR). Because the signal to be transmitted by the base station may have a large dynamic range, the power amplifier should be designed to accommodate this range while still being able to amplify the signal linearly without introducing excessive inter-modulation distortion. Power amplifiers, however, tend to be one of the largest and more expensive components in the base station (e.g., 15-20% of the base station's total cost), and its cost often increases as the dynamic range of the signal to be amplified increases. It is therefore desirable to incorporate PAR reduction methods within the base station to reduce the PAR of the signal, allowing reduction of the power amplifier size and therefore the reduction of the total base station cost.

To keep base station costs down, base stations currently use a single power amplifier to handle multiple carriers (e.g., 2, 3 or 4 carriers) rather than a single carrier. In other words, the multiple carriers are sent through a common amplifier, such as a multiple carrier linear amplifier (MCLA), to handle the overall spectrum for all the carriers.

Some PAR reduction techniques limit the peaks of a transmitted signal by clipping baseband in-phase and quadrature components of the signal if they exceed a selected threshold to prevent the PAR of the signal from exceeding the capabilities of the power amplifier in the base station. This method works well for single carrier systems, but in multiple carrier systems, peak limiting of the baseband signals corresponding to each of the carriers is often not sufficient. This is because clipping the peaks of each multi-channel signal may not prevent the signal corresponding to the sum of the carriers from exceeding the threshold. Once the carriers are added together before the power amplifier stage, the PAR of the resulting composite carrier may still be above the selected threshold due to the peak regrowth even if the PAR of the individual carriers each fall below the selected threshold. The actual amount of peak regrowth in the composite signal is a function of, for example, instantaneous peaks in the individual carriers, the phase angle between the carriers, and the number of carriers amplified by one MCLA and transmitted by the base station.

There is currently no known way to reduce the PAR for composite carriers because currently known methods, which reduce the PAR for single carriers, cannot anticipate the effect of combining two or more carriers on the PAR of the resulting composite carrier. As a result, composite carriers still exhibit excessive PAR, requiring a larger multi-carrier amplifier in the base station to accommodate the PAR.

### SUMMARY OF THE INVENTION

The present invention is directed to a method for reducing the PAR of a composite carrier formed by summing two or more single carriers. The method may include obtaining the multi-channel baseband in-phase and quadrature components to each of the carriers, computing vector magnitudes corresponding to each carrier, then adding the vector magnitudes to generate a composite magnitude. At least of the one of the carriers may be attenuated based on the composite magnitude value, reducing the PAR of the composite carrier. In one embodiment, only the carrier or carriers having significantly larger vectors are attenuated.

By pre-calculating the vector magnitudes of the multi-channel baseband signals corresponding to each carrier before sending the composite of the carriers to the power amplifier, the inventive method can reduce the transmitted PAR of the composite carrier and avoid peak regrowth.

### BRIEF DESCRIPTION OF THE DRAWINGS

FIG. 1 is a block diagram illustrating a broad concept of the inventive method;

FIG. 2 is a flow diagram illustrating one embodiment of the invention; and

FIG. 3 is a flow diagram illustrating another embodiment of the invention.

### DETAILED DESCRIPTION

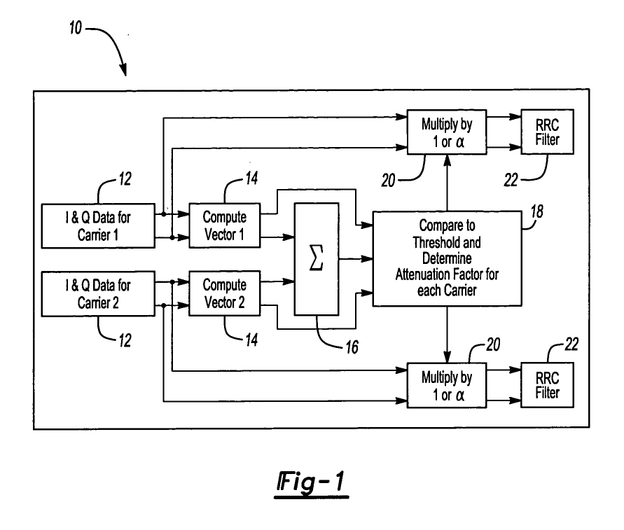

FIG. 1 is a block diagram 10 that illustrates the general concept set forth by the inventive method. In the examples described below, it is assumed that the base station is transmitting a two-carrier transmission; however, the invention can be applied to systems having any number of carriers and is not limited to the illustrated examples. The inventive method generally obtains the in-phase (I) and quadrature (Q) components of each carrier (block 12) and computes vectors from these components (block 14). The vectors corresponding to the two carriers are then added together (block 16), and the resulting sum is compared with a threshold to determine whether either or both carriers should be attenuated (block 18).

The I and Q components of the two carriers (block 12) may then multiplied by 1 or an attenuation factor α (block 20), depending on the results of the comparison (block 18). In this example, once the carrier components have been attenuated, they are sent to a root raised cosine (RRC) filter (block 22) for further processing before signal transmission.

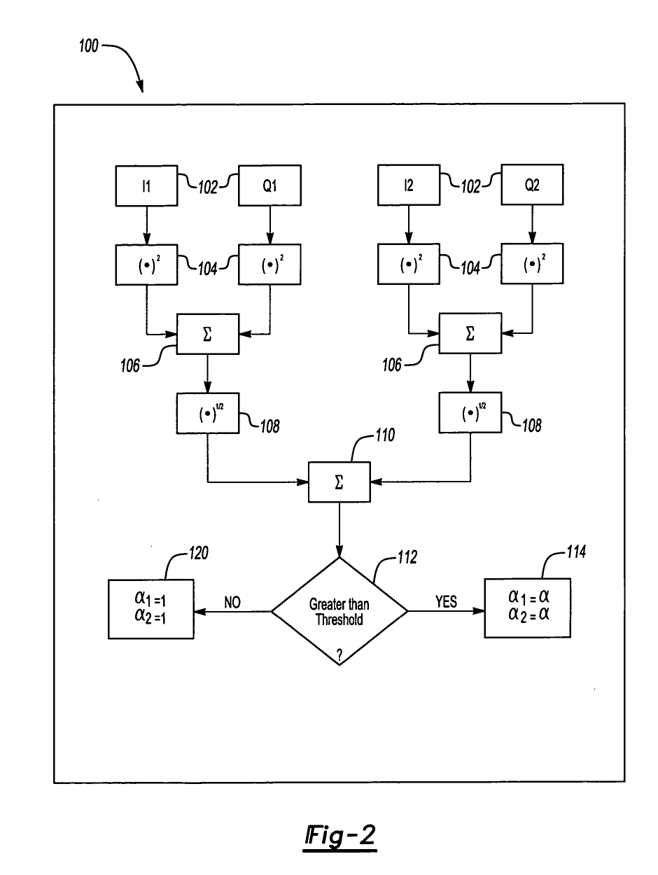

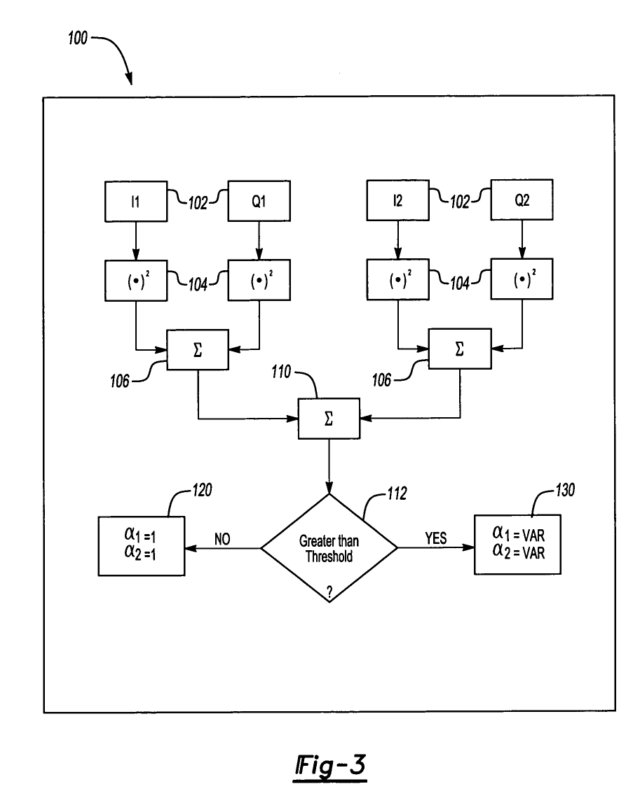

FIGS. 2 and 3 show two possible embodiments for calculating attenuation factors for the different carriers. The actual processing of the signals before transmission is shown in FIG. 1.

FIG. 2 is a representative diagram generally illustrating one embodiment of the inventive method for calculating the attenuation factors for the different carriers to be transmitted after processing as depicted in FIG. 1. In this example, it is assumed that each carrier is phase shift key (PSK) modulated with its own corresponding multi-channel baseband CDMA signal, combined with other carriers, and then power amplified by, for example, a multi-carrier linear amplifier (MCLA). As noted above, the composite carrier may be peak-limited to reduce the transmitted peak-to-average power ratio (PAR) and therefore reduce the demands on the power amplifier.

Generally, the inventive method comprises obtaining the in-phase and quadrature components of the multi-channel baseband signal corresponding to each of the carriers, computing vector magnitudes corresponding to each carrier, adding the vector magnitudes and then comparing the resulting sum to a threshold. If the sum exceeds the threshold, at least of the one of the carriers may be attenuated, reducing the PAR of the composite carrier. The method itself can be executed in any known manner, such as through a processor executing an algorithm embodying the inventive method.

Referring to FIG. 2, the inventive method 100 first obtains the in-phase (I) and quadrature (Q) components of each carrier (block 102). Vector magnitudes corresponding to each carrier (e.g., Carrier 1 and Carrier 2) are then computed from the in-phase and quadrature components of each carrier (block 104) as follows:
Vector1=sqrt(I1²+Q1²) Equation 1
Vector2=sqrt(I2²+Q2²) Equation 2

As can be seen in the Equations, the vector magnitudes corresponding to each carrier in this embodiment may be calculated by squaring the in-phase I and quadrature phase Q components of each carrier (block 104), adding the squared components of each carrier together (block 106), and then taking the square root of the sum (block 108). The vector magnitudes of each individual carrier may then be added together to obtain a composite vector magnitude for the composite carrier (block 110). This composite vector magnitude is simply a pre-calculation that reflects the potential PAR of the composite carrier when the carriers are modulated by their multi-channel baseband signals, combined, power amplified by the MCLA and finally transmitted. This calculation may assume a worst-case scenario where the component carriers in the composite carrier constructively interfere with each other, ensuring that the eventual decision of whether or not to reduce the transmitted PAR will present the PAR from exceeding the operational boundaries of the power amplifier.

Note that the composite vector magnitude computation, which represents a theoretical combination of the carriers for calculation purposes only, is conducted in the baseband domain before the signals actually RF modulate the respective carriers, which involves the process of the carriers being combined and then sent to the power amplifier. Thus, the inventive method makes the composite carrier available to the power amplifier such that an appropriate composite carrier PAR reduction (if any) process is complete. This allows the composite carrier PAR to be controlled without having to compensate for any non-linearities in the power amplifier.

The composite vector magnitude may then be compared with a threshold to determine whether some or all of the carriers should be attenuated (block 112). If the calculated composite vector magnitude is greater than the threshold, this indicates that the PAR of the composite carrier will exceed the operational boundaries of the power amplifier if the individual carriers are left unattenuated.

In one embodiment, as shown in FIG. 1, all of the individual carriers forming the composite carrier are attenuated by an attenuation factor α. This factor α can be defined as:
α=thresh/amp=(r*level)/amp Equation 3
where level=the maximum allowable combined vector magnitude
amp=Vector 1+Vector 2 (the sum of all the vector magnitudes in the composite carrier)
r=desired factor for determining the final clipping amount
   In actual practice, the different carriers may be attenuated by -c's that are different from each other corresponding to the different carriers.

The specific value for r for different carriers generally depends on the statistics of the multi-channel baseband signal modulating a particular carrier. Preliminary values for r may be obtained via simulations and then fine-tuned by on-site measurements taken as part of an installation or servicing procedure. For example, if the first carrier has the multi-channel signals which are predominantly voice and the second carrier has multi-channel signals that are predominantly data, then generally Vector 1>>Vector 2 in this case and hence r=1 for ∝₁ and ∝₂=1. Conversely, if the first carrier is a predominantly data bearing carrier and the second carrier is a predominantly voice bearing carrier, Vector 2>>Vector 1 and therefore ∝₁=1 and r=1 for ∝₂. In another example, if both of the two carriers have multi-channel base-band signals with fairly identical statistics, for both ∝₁ and ∝₂ r=2. Those of ordinary skill in the art will be able to discern that other values for r may be possible without departing from the scope of the invention.

By multiplying each individual carrier by the attenuation factor α (block 114), the PAR of each carrier is reduced enough to prevent peak regrowth in the PAR of the composite carrier above the operational limits of the power amplifier. Once the individual carriers have been attenuated separately, they are processed in the manner shown in FIG. 1.

In another embodiment, shown in FIG. 3, only some of the individual carriers are attenuated if the composite vector magnitude is determined in block 112 to be above the selected threshold. As shown in the FIG. 3, the value for a is variable (i.e., α=VAR) (block 130) in this embodiment and may not be equal for each carrier. As noted above, the value α for can be changed by varying the value for r. If the magnitude of, for example, Vector 2 is significantly larger (e.g., on the order of ten or more times larger) than the magnitude of Vector 1, then the method will attenuate only Carrier 2, leaving Carrier 1 unattenuated. In this case, the value of r for the larger carrier is 1. This ensures that only the carriers contributing to the high PAR in the composite carrier will be attenuated, leaving the weaker carriers unchanged.

Further, as shown in FIG. 3, the squared in-phase and quadrature components are added together in calculating the vector magnitude value as described above, but the square root of the sum is not taken. In this case, the vector magnitude value used for comparison purposes is the square of the actual vector magnitude. This simplified calculation is more economical to implement because it does not require extra processing resources that are normally needed for carrying out a square root function.

If the composite vector magnitude is less than the threshold, however, this indicates that the PAR of the composite carrier will remain within the operational boundaries of the power amplifier. The baseband processor then decides whether to attenuate one or more of the carriers and determines what the actual attenuation factor should be based on the relative characteristics of the multi-channel baseband signal modulating the individual carriers. To maintain the existing composite carrier values in the embodiments of both FIG. 2 and FIG. 3, α in this case for both carriers is set equal to 1 (block 120).

Regardless of the specific way the carriers are attenuated, it should be noted that the processes shown in FIGS. 2 and 33 may be conducted in the digital domain to predict the PAR of the composite carrier in the analog domain. This is easier than actually combining the composite carrier before evaluating its PAR because any processing of the composite carrier in the analog domain will create distortion. Thus, the peak reduction methods shown in FIGS. 1 and 2 may be carried out at the baseband level before the carriers are actually combined, amplified, and transmitted along with their associated signals.

In one embodiment, implementation of the inventive method may be conducted digitally in the base station at a baseband processing stage using field programmable gate arrays (FPGAs). Digital implementation of the inventive method eliminates the need to lock the phases of the carriers before determining whether the carriers need to be attenuated. Further, because all of the processing may be conducted in the baseband, implementation of the inventive method can be kept simple. Using FPGAs allows the method to be modified to accommodate different CDMA standards and different carrier attenuation schemes by simply changing the firmware in the FPGA. Further, by evaluating the potential PAR of the composite carrier at the baseband level, the invention pre-empts the PAR of the composite carrier from exceeding the predetermined threshold without actually combining the carriers.

As a result, the invention ensures that the overall PAR for a composite carrier will be bound by a predefined limiting threshold reflecting the operational limitations of the power amplifier. Note that although the illustrated examples focus on a two-carrier system, the inventive method may be used in any multi-carrier application having any number of carriers.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, this method, system and portions thereof and of the described method and system may be implemented in different locations, such as network elements, the wireless unit, the base station, a base station controller, a mobile switching center and/or radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A method comprising:
calculating at least a first and second vector magnitude value corresponding to at least a first carrier and a second carrier, respectively;
calculating a composite vector magnitude from the first and second vector magnitude values; and
attenuating at least one of the first and second carriers based on the composite vector magnitude.

2. The method of claim 1, wherein composite vector magnitude corresponds to a composite carrier comprising at least the first and second carriers.

3. The method of claim 1, wherein each carrier comprises an in-phase component and a quadrature phase component, and wherein each vector magnitude value is calculated by:
squaring the in-phase component and the quadrature component; and
summing the squares of the in-phase component and the quadrature component to obtain the composite vector magnitude.

4. The method of claim 1, wherein each carrier comprises an in-phase component and a quadrature phase component, and wherein each vector magnitude value is calculated by:
squaring the in-phase component and the quadrature component;
summing the squares of the in-phase component and the quadrature component; and
taking the square root of the sum of the squares of the in-phase and quadrature components to obtain the composite vector magnitude.

5. The method of claim 1, further comprising comparing the composite vector magnitude with a threshold, wherein the attenuating step is conducted if the composite vector magnitude exceeds the threshold.

6. The method of claim 5, wherein the attenuating step comprises multiplying at least one of the first and second carrier by an attenuation factor.

7. The method of claim 6, wherein the attenuation factor is based on characteristics of a multi-channel baseband signal modulating at least one of said first and second carrier.

8. The method of claim 1, further comprising:
comparing the first vector magnitude value with the second vector magnitude value; and
attenuating the first carrier if the first vector magnitude value is larger than the second vector magnitude value.

9. The method of claim 6, wherein the attenuating step is conducted if the first vector magnitude value is larger by a selected magnitude than the second vector magnitude value.

10. The method of claim 1, wherein the vector magnitude calculating step, the composite vector magnitude calculating step, the comparing step, and the attenuating step are carried out at a baseband processing stage.

11. A method for a plurality of carriers, each carrier having an in-phase component and a quadrature phase component, the method comprising:
calculating a plurality of vector magnitude values, each vector magnitude value corresponding to one of said plurality of carriers and calculated by squaring the in-phase component and the quadrature component of the carrier and summing the squares of the in-phase component and the quadrature component;
calculating a composite vector magnitude from the plurality of magnitude values; vector; and
attenuating at least one of the plurality of carriers by an attenuation factor based on the composite vector magnitude.

12. The method of claim 11, wherein calculating the vector magnitude value further comprises taking the square root of the sum of the squares of the in-phase and quadrature components to obtain the vector magnitude value.

13. The method of claim 11, wherein the attenuation factor is based on characteristics of a multi-channel baseband signal modulating at least one of said first and second carrier.

14. The method of claim 11, further comprising:
comparing at least two of said plurality of vector magnitude values; and
attenuating at least one of said plurality of carriers based on the comparing step if at least one of said carriers is larger by a selected magnitude than another vector magnitude value.

15. The method of claim 11, wherein the vector magnitude calculating step, the composite vector magnitude calculating step, the comparing step, and the attenuating step are carried out at a baseband processing stage.

16. The method of claim 11, further comprising comparing the composite vector magnitude with a threshold, wherein the attenuating step is conducted if the composite vector magnitude exceeds the threshold.
